(19) United States
(12) Patent Application Publication
(10) Pub. No.: US 2024/0287693 A1
(43) Pub. Date: Aug. 29, 2024

(54) ELECTROCHEMICAL REDUCTION OF CARBON DIOXIDE CATALYZED BY POLYOXOMETALATES

(71) Applicant: YEDA RESEARCH AND DEVELOPMENT CO. LTD., Rehovot (IL)

(72) Inventors: Ronny NEUMANN, Kfar Saba (IL); Dima DABBAH-AZAIZA, Rehovot (IL); Ariel ROSENMAN, Rehovot (IL); Avra TZAGUY, Rehovot (IL)

(73) Assignee: YEDA RESEARCH AND DEVELOPMENT CO. LTD., Rehovot (IL)

(21) Appl. No.: 18/560,386

(22) PCT Filed: May 25, 2022
(86) PCT No.: PCT/IL2022/050551

§ 371 Date: Nov. 12, 2023

(30) Foreign Application Priority Data
May 26, 2021 (IL) 283483

(51) Int. Cl. C25B 11/085; C01B 33/20; C07F 19/00; C25B 1/23; C25B 3/26; C25B 11/077

(52) U.S. Cl. CPC C25B 11/085; C01B 33/20; C07F 19/005; C25B 1/23; C25B 11/077; C01P 2002/50; C01P 2002/77; C25B 3/26

(57) ABSTRACT

Provided herein a polyoxometalate compound represented by formula (I): (Q)ₙ[XMₐM_{b}M_{c}(Lₐ)(L_{b})(L_{c})W₉O₃₇] (I) or a solvate thereof; and a method of electrocatalytic reduction of carbon dioxide (CO₂) using the polyoxometalate compound.

### FIELD OF THE INVENTION

This invention provides a polyoxometalate compound represented by formula (I): (Q)ₙ[XMₐM_{b}M_{c}(Lₐ)(L_{b})(L_{c})W₉O₃₇] (I) or a solvate thereof; and a method of electrocatalytic reduction of carbon dioxide (CO₂) using the polyoxometalate compound.

### BACKGROUND OF THE INVENTION

Fixation and further utilization of gaseous carbon dioxide is one of the most significant achievements of nature and one of the most important objectives of environmental and energy related chemistry. Carbon dioxide is the main greenhouse gas that is produced by human activity, and has brought the atmospheric CO₂ concentration level over the threshold of 400 ppm. This increase is encouraging the search for methods to transform CO₂ into valuable chemicals (Cokoja, M.; Bruckmeier, C.; Rieger, B.; Herrmann, W. A.; Kühn, F. E. Transformation of Carbon Dioxide with Homogeneous Transition-Metal Catalysts: A Molecular Solution to a Global Challenge? Angew. Chemie—Int. Ed. 2011, 50, 8510-8537.) One of the most investigated transformations is the photochemical or the electrochemical reduction of CO₂ to carbon monoxide as versatile intermediate for further known transformations to usable products. Other reduction products of interest are methanol, and further C—C couple compounds such as ethanol. Unfortunately, the direct electro-assisted reduction of CO₂ on a bare electrode is a kinetically slow process that is characterized by large overpotentials due to the multi-electronic nature of the reactions and the fundamental requirement for the reorganization of the CO₂ molecular structure (Mikkelsen, M.; Jørgensen, M.; Krebs, F. C. The Teraton Challenge. A Review of Fixation and Transformation of Carbon Dioxide. Energy Environ. Sci. 2010, 3, 43-81; Appel, A. M.; Bercaw, J. E.; Bocarsly, A. B.; Dobbek, H.; Dubois, D. L.; Dupuis, M.; Ferry, J. G.; Fujita, E.; Hille, R.; Kenis, P. J. A.; Kerfeld, C. A.; Morris, R. H.; Peden, C. H. F.; Portis, A. R.; Ragsdale, S. W.; Rauchfuss, T. B.; Reek, J. N. H.; Seefeldt, L. C.; Thauer, R. K.; Waldrop, G. L. Frontiers, Opportunities, and Challenges in Biochemical and Chemical Catalysis of CO₂ Fixation. Chem. Rev. 2013, 3, 6621-6658.

In this context, many organometallic complexes have been studied for electrocatalytic CO₂ reduction (Franke, R.; Schille, B.; Roemelt, M. Homogeneously Catalyzed Electroreduction of Carbon Dioxide-Methods, Mechanisms, and Catalysts. Chem. Rev. 2018, 118, 4631-4701), but most have some disadvantages. For example, some transition metals that are commonly studied are rare and expensive; some complexes are not stable during the electrocatalytic reduction reaction and the synthesis of preferred ligands is complicated and not economical. Accordingly, we have invented the use of soluble inorganic metal oxide clusters, that is polyoxometalates, as electrocatalysts for CO₂ reduction. Polyoxometalates can be considered as clusters, generally anionic, formed from monomeric oxo species of transition metals with one or more bridging oxygen atoms. The interest in polyoxometalate chemistry is largely due to their structures, size, redox activity, solubility, thermal stability and charge density. Over the years, the modification of the precursors of parent polyoxometalates has led to the development of a new classes of compounds with unique structure and electronic properties. The original polyoxometalates with the substitution of transition additional metal ions are known as “transition metal substituted polyoxometalates” (Pope, M. T. Heteropoly and Isopoly Oxometalates, 8th ed.; Springer-Verlag: Berlin; New York, 1983.).

Polyoxometalates are attractive as catalysts because they are easy to synthesize, thermally and oxidatively stable, their intrinsic properties may be modified easily and they can be used with excellent efficiency in transformations involving electron transfer (Neumann, R. Activation of Molecular Oxygen, Polyoxometalates and Liquid Phase Catalytic Oxidation. Inorg. Chem. 2010, 49, 3594-3601.) Furthermore, many of these polyoxometalates display reversible redox processes that are sensitive to the presence of protons. Although they are weak bases and nucleophiles, polyoxometalates can promote the formation of hydrogen-bond networks in the vicinity of a CO₂ coordination center to favor proton coupled electron transfer (Girardi, M.; Blanchard, S.; Griveau, S.; Simon, P.; Fontecave, M.; Bedioui, F.; Proust, A. Electro-Assisted Reduction of CO 2 to CO and Formaldehyde by (TOA)₆[α-SiW₁₁O₃₉Co(_)] Polyoxometalate. Eur. J. Inorg. Chem. 2015, 3642-3648). The substitution of a lacunary polyoxometalate with transition metals increases the reactivity of the polyanion, which normally have surfaces that are populated with weakly basic oxygen atoms. As a rational approach to such complexes, lacunary anions such as α- or β-[SiW₉O₃₄]⁹⁻ were prepared (G. Herve and A. Teze, Study of alpha-and. beta.-enneatungstosilicates and-germanates Inorg. Chem., 1977, 16, 2115-2117) and then used to further prepare tri-metal substituted polyoxometalates by inclusion of metal cations into the lacunary positions. In this way polyoxometalate anions, [SiW₉M₃(L)₃O₃₇]ⁿ⁻ (FIG. 1) where M=Co(II), Fe(III), Cu(II), Mn(II), Ni(II), Cr(III), Al(III), and Ga(III) have been prepared. (Liu, J.; Ortega, F.; Sethuraman, P.; Katsoulis, D. E.; Costello, C. E.; Pope, M. T. Trimetallo Derivatives of Lacunary 9-Tungstosilicate. J. Chem. Soc., Dalton Trans. 1992, 1901-1906). There are also reports where Fe(III) has included with another metal has been into the lacunary position to form [PW₉O₃₇{Fe^{III}₃₋ₓNiₓ(OAc)₃}]^{(9+x)-} or [SiW₉(Fe^{III})₂M′(L)₃O₃₇]ⁿ⁻ where M′ is Ni(II), Co(II) or Mn(II) (Mizuno, N.; Nozaki, C.; Horose, T.; Tateishi, M.; Iwamoto, M. Liquid-phase oxygenation of hydrocarbons with molecular oxygen catalyzed by Fe, Ni-substituted Keggin-type heteropolyanion. J. Mol. Catal. A: Chem. 1997, 117, 159-168 and Girardi, M. Application des dérivés métalliques des polyoxométallates pour la catalyse d′électroréduction de CO₂ Université Pierre et Marie Curie, Paris VI 2016).

All known molecular and material electrocatalysts require rather high overpotentials for the electroreduction of CO₂, where a major objective is to find catalysts with low overpotentials thus requiring less electricity energy to drive the catalytic reactions. Reductions of CO₂ are usually coupled with proton transfer in order to overcome the very endergonic transfer of a single electron to CO₂ to form the anion radical, CO₂^{•-}. These proton coupled electron transfer reactions still have slow kinetics, and require efficient catalysts in order to decrease the overpotentials that needed to drive the reactions. Saveant and co-workers added Mg²⁺ cations as Lewis acids to increase the rate of the Fe tetraphenylporphyrin (FeTPP) reduction of CO₂ to CO and thereby in addition improved the stability of catalyst (Hammouche, M.; Lexa, D.; Momenteau, M.; Savéant, J.-M. Chemical catalysis of electrochemical reactions. Homogeneous catalysis of the electrochemical reduction of carbon dioxide by iron (“0”) porphyrins. Role of the addition of magnesium cations. J. Am. Chem. Soc. 1991, 113, 8455-8466). It is thought that these Lewis acids facilitate the breaking of one of the C—O bonds of a bound CO₂ ligand to produce CO. In another paper the use of Lewis acids in place of Brønsted acids, to increase the rate of catalysis for Mn bipyridine type catalysts was reported (Sampson, M. D.; Kubiak, C. P. Manganese Electrocatalysts with Bulky Bipyridine Ligands: Utilizing Lewis Acids To Promote Carbon Dioxide Reduction at Low Overpotentials. J. Am. Chem. Soc. 2016, 138, 1386-1393). In fact two catalytic regimes were observed, fast reactions with high trunover at high overpotentials, uneffected by Lewis acids and slower reaction with low turnover at low overpotentials.

### SUMMARY OF THE INVENTION

In one embodiment, this invention is directed to a polyoxometalate compound represented by formula (I):

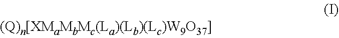

or a solvate thereof,
wherein,
X is P, Si, As, Ge, Ga, B, or Al;
Mₐ, M_{b} and M_{c} are each independently selected from the group consisting of: Cr, Mn, Fe, Co, Ni, Cu, Zn, Al, Ga, Sn, Sb, In, Sc, Sr, Mg, Y, Yb, Ba and Ca;
Lₐ, L_{b} and L_{c} are each independently selected from the group consisting of: H₂O, carboxylates, oxyanions, halides or pseudohalides, carbonate, bicarbonate or absent;
Q is a cation such as a proton, an alkali metal cation, an alkaline earth metal cation, a lanthanide cation, a nitrogen centered cation or a phosphorous centered cation or any combination thereof;
n is an integer between 4-13; and wherein at least one of Mₐ, M_{b} and M_{c} is Sn, Al, Zn or Ga or Mₐ, M_{b} and M_{c} are different.

In one further embodiment, this invention provides a method of reducing carbon dioxide to carbon monoxide, formate salt or formic acid, formaldehyde, methanol, ethane, ethylene, ethanol or any combination thereof, wherein the method comprises reacting carbon dioxide with a polyoxometalate compound represented by formula (I):

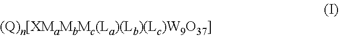

or a solvate thereof,
wherein,
X is P, Si, As, Ge, Ga, B, or Al;
Mₐ, M_{b} and M_{c} are each independently selected from the group consisting of: Cr, Mn, Fe, Co, Ni, Cu, Zn, Al, Ga, Sn, Sb, In, Sc, Sr, Mg, Y, Yb, Ba and Ca;
Lₐ, L_{b} and L_{c} are each independently selected from the group consisting of: H₂O, carboxylates, oxyanions, halides or pseudohalides, carbonate, bicarbonate or absent;
Q is a cation such as a proton, an alkali metal cation, an alkaline earth metal cation, a lanthanide cation, a nitrogen centered cation or a phosphorous centered cation or any combination thereof; n is an integer between 4-13;
and wherein the reaction is conducted in an electrochemical cell comprising: a cathode, an anode, optionally a reference electrode, optionally a membrane; and the polyoxometalate compound of Formula (I) as the catalyst for the reduction of carbon dioxide.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts a mixed polyhedral and ball and stick representation of the {SiMₐM_{b}M_{c} (H₂O)₃W₉O₃₇}ⁿ⁻ anion: external octahedrons—W; internal tetrahedron at the middle—Si; three balls at the top—Mₐ/M_{b}/M_{c}; small, light gray balls—O. The hydrogen atoms and counter cations are not shown.

FIGS. 2A-2B depict a presentation of an electrolyzer. FIG. 2A: Schematic design; and FIG. 2B: a photograph of the electrolyzer.

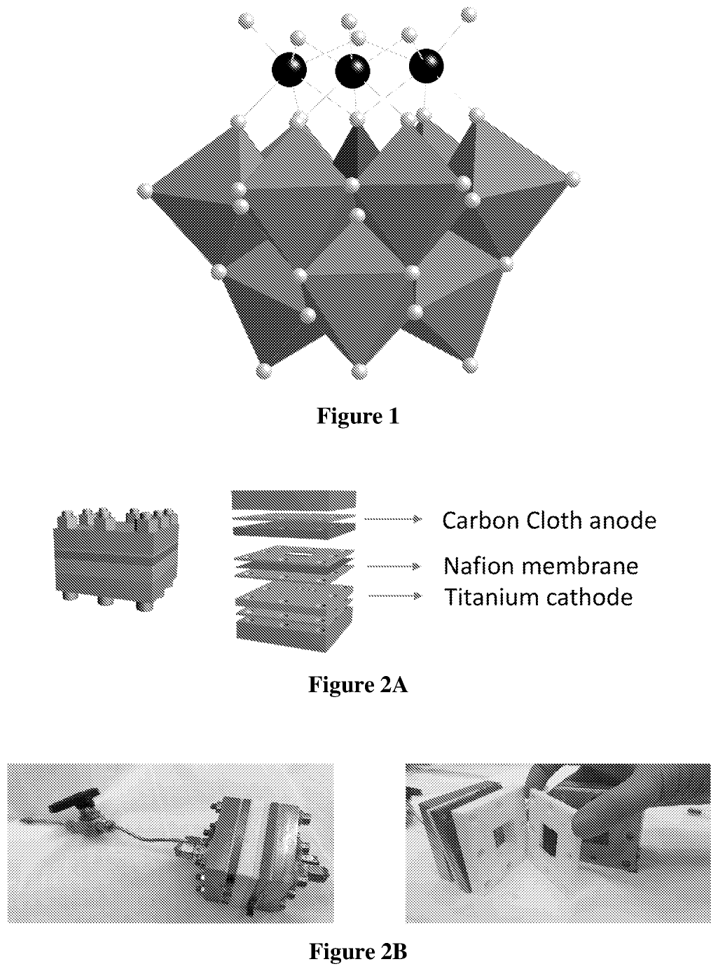

It will be appreciated that for simplicity and clarity of illustration, elements shown in the Figures have not necessarily been drawn to scale. For example, the dimensions of some of the elements may be exaggerated relative to other elements for clarity. Further, where considered appropriate, reference numerals may be repeated among the Figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that this invention may be practiced without these specific details. In other instances, well-known methods, procedures, and components have not been described in detail so as not to obscure this invention.

Polyoxometalate Compound of this Invention

In some embodiments, this invention provides a polyoxometalate represented by formula (I):

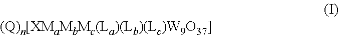

or a solvate thereof,
wherein,
X is P, Si, As, Ge, Ga, B, or Al;
Mₐ, M_{b} and M_{c} are each independently selected from the group consisting of: Cr, Mn, Fe, Co, Ni, Cu, Zn, Al, Ga, Sn, Sb, In, Sc, Sr, Mg, Y, Yb, Ba and Ca;
Lₐ, L_{b} and L_{c} are each independently selected from the group consisting of: H₂O, carboxylates, oxyanions, halides or pseudohalides, carbonate, bicarbonate or absent;
Q is a cation such as a proton, an alkali metal cation, an alkaline earth metal cation, a lanthanide cation, a nitrogen centered cation or a phosphorous centered cation or any combination thereof;
n is an integer between 4-13.

In some embodiments, this invention provides a polyoxometalate represented by formula (I):

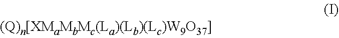

or a solvate thereof,
wherein,
X is P, Si, As, Ge, Ga, B, or Al;
Mₐ, M_{b} and M_{c} are each independently selected from the group consisting of: Cr, Mn, Fe, Co, Ni, Cu, Zn, Al, Ga, Sn, Sb, In, Sc, Sr, Mg, Y, Yb, Ba and Ca;
Lₐ, L_{b} and L_{c} are each independently selected from the group consisting of: H₂O, carboxylates, oxyanions, halides or pseudohalides, carbonate, bicarbonate or absent;
Q is a cation such as a proton, an alkali metal cation, an alkaline earth metal cation, a lanthanide cation, a nitrogen centered cation or a phosphorous centered cation or any combination thereof;
n is an integer between 4-13 wherein at least one of Mₐ, M_{b} and M_{c} is Sn, Al, Zn or Ga.

In some embodiments, this invention provides a polyoxometalate represented by formula (I):

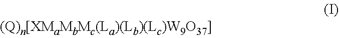

or a solvate thereof,
wherein,
X is P, Si, As, Ge, Ga, B, or Al;
Mₐ, M_{b} and M_{c} are each independently selected from the group consisting of: Cr, Mn, Fe, Co, Ni, Cu, Zn, Al, Ga, Sn, Sb, In, Sc, Sr, Mg, Y, Yb, Ba and Ca;
Lₐ, L_{b} and L_{c} are each independently selected from the group consisting of: H₂O, carboxylates, oxyanions, halides or pseudohalides, carbonate, bicarbonate or absent;
Q is a cation such as a proton, an alkali metal cation, an alkaline earth metal cation, a lanthanide cation, a nitrogen centered cation or a phosphorous centered cation or any combination thereof;
n is an integer between 4-13 wherein at least two out of Mₐ, M_{b} and M_{c}—are different.

In some embodiments, this invention provides a polyoxometalate represented by formula (I):

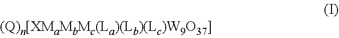

or a solvate thereof,
wherein,
X is P, Si, As, Ge, Ga, B, or Al;
Mₐ, M_{b} and M_{c} are each independently selected from the group consisting of: Cr, Mn, Fe, Co, Ni, Cu, Zn, Al, Ga, Sn, Sb, In, Sc, Sr, Mg, Y, Yb, Ba and Ca;
Lₐ, L_{b} and L_{c} are each independently selected from the group consisting of: H₂O, carboxylates, oxyanions, halides or pseudohalides, carbonate, bicarbonate or absent;
Q is a cation such as a proton, an alkali metal cation, an alkaline earth metal cation, a lanthanide cation, a nitrogen centered cation or a phosphorous centered cation or any combination thereof;
n is an integer between 4-13 wherein Mₐ, M_{b} and M_{c} are different (representing three different metal selected from Cr, Mn, Fe, Co, Ni, Cu, Zn, Al, Ga, Sn, Sb, In, Sc, Sr, Mg, Y, Yb, Ba and Ca).

In another embodiment, non-limiting examples of oxyanion include: borate, carbonate, nitrate, phosphate, sulphate, chlorate, perchlorate, iodate, periodate, tosylate, mesylate and triflate.

In another embodiment, the anion of the polyoxometalate is not [PW₉O₃₇{Fe^{III}₃₋ₓNiₓ(L)₃}]^{q-} (x=1-2), [SiW₉(Fe^{III})₂Ni^{II}(L)₃O₃₇]ⁿ⁻, [SiW₉(Fe^{III})₂Mn^{II}(L)₃O₃₇]ⁿ⁻, or [SiW₉(Fe_{III})₂Co^{II}(L)₃O₃₇]ⁿ⁻.

In some embodiments Q of (Q)ₙ[XMₐM_{b}M_{c}(Lₐ)(L_{b})(L_{c})W₉O₃₇] is a cation selected from the group consisting of a proton, an alkali metal cation, an alkaline earth metal cation, a lanthanide cation, a nitrogen centered cation, a phosphorous centered cation and combinations thereof. In other embodiments, Q is a proton. In other embodiments, Q is an alkali metal cation. In other embodiments, Q is an alkaline earth metal cation. In other embodiments, Q is a lanthanide cation. In other embodiments, Q is a nitrogen centered cation. In other embodiments, Q is a phosphorous centered cation. In other embodiments, Q is R₁R₂R₃R₄N⁺ wherein
R₁ is H, alkyl, aryl, alkylaryl;
R₂ is H, alkyl, aryl, alkylaryl, or C_{y}H_{2y+1} where y≥8, or C_{z}H_{2z+1}COOH where z≥7; and
R₃ and R₄ are each independently H, alkyl, aryl, alkylaryl, or (CH₂CH₂O)ₘCH₂CH₂R₅ where m≥3, wherein R₅ is H, OH, alkyl, halide, pseudohalide.

In some embodiments, Q is R₁R₂R₃R₄N⁺ wherein R₂ is C_{y}H_{2y+1} where y≥8. In other embodiments y is an integer between 8 and 50. In other embodiments, y is an integer between 8 and 40. In other embodiments, y is an integer between 8 and 30. In other embodiments, y is an integer between 8 and 20.

In some embodiments, Q is R₁R₂R₃R₄N⁺ wherein R₂ is C_{z}H_{2z+1}COOH where y≥7. In other embodiments z is an integer between 7 and 50. In other embodiments, z is an integer between 7 and 40. In other embodiments, z is an integer between 7 and 30. In other embodiments, z is an integer between 7 and 20.

In some embodiments, Q is R₁R₂R₃R₄N⁺ wherein R₃ and R₄ are the same or different. In some embodiments, R₃ and R₄ are each independently (CH₂CH₂O)ₘCH₂CH₂R₅ where m≥3. In other embodiments. m is an integer between 3 and 50. In other embodiments, m is an integer between 3 and 40. In other embodiments, m is an integer between 3 and 30. In other embodiments. m is an integer between 3 and 20. In other embodiments. m is an integer between 3 and 15. In other embodiments. m is an integer between 3 and 10.

In some embodiments, Q is R₁R₂R₃R₄N⁺ wherein R₁ is ethyl, R₂ is C_{z}H_{2z+1}COOH wherein z≥7 and R₃ and R₄ are (CH₂CH₂O)ₘH where m=6-20. In other embodiments, Q is R₁R₂R₃R₄N⁺ wherein R₁ is methyl; R₂ is tetradecyl, hexadecyl or octadecyl; and R₃ and R₄ are (CH₂CH₂O)ₘH where m=5-10.

In some embodiments, Q of the polyoxometalate of Formula (I)-(Q)ₙ[XMₐM_{b}M_{c}(Lₐ)(L_{b})(L_{c})W₉O₃₇] is a nitrogen centered cation, non-limiting examples thereof include quaternary ammonium, pyridinium and imidazolium cations.

In one embodiment, quaternary ammonium is selected from the group consisting of tetrahexyl ammonium, tetrabutyl ammonium, trioctylmethylammonium, cetyltrimethyl ammonium, tetraoctyl ammonium, tetraethylammonium, tetramethylammonium, benzyltrimethylammonium, and the like. Each possibility represents a separate embodiment of this invention.

In some embodiments, one example of phosphorous centered cation includes phosphonium cations, e.g. tetraphenylphosphonium.

As used herein, the term “alkyl”, used alone or as part of another group, refers, in one embodiment, to a “C₁ to C₁₂ alkyl” and denotes linear and branched, saturated or unsaturated (e.g., alkenyl, alkynyl) groups, the latter only when the number of carbon atoms in the alkyl chain is greater than or equal to two, and can contain mixed structures. Non-limiting examples are alkyl groups containing from 1 to 6 carbon atoms (C₁ to C₆ alkyls), or alkyl groups containing from 1 to 4 carbon atoms (C₁ to C₄ alkyls). Examples of saturated alkyl groups include, but are not limited to, methyl, ethyl, n-propyl, isopropyl, n-butyl, iso-butyl, sec-butyl, tert-butyl, amyl, tert-amyl and hexyl. Examples of alkenyl groups include, but are not limited to, vinyl, allyl, butenyl and the like. Examples of alkynyl groups include, but are not limited to, ethynyl, propynyl and the like. Similarly, the term “C₁ to C₁₂ alkylene” denotes a bivalent radical of 1 to 12 carbons.

The alkyl group can be unsubstituted, or substituted with one or more substituents selected from the group consisting of halogen, hydroxy, alkoxy, aryloxy, alkylaryloxy, heteroaryloxy, oxo, cycloalkyl, phenyl, heteroaryls, heterocycl, naphthyl, amino, alkylamino, arylamino, heteroarylamino, dialkylamino, diarylamino, alkylarylamino, alkylheteroarylamino, arylheteroarylamino, acyl, acyloxy, nitro, carboxy, carbamoyl, carboxamide, cyano, sulfonyl, sulfonylamino, sulfinyl, sulfinylamino, thiol, alkylthio, arylthio, or alkylsulfonyl groups. Any substituents can be unsubstituted or further substituted with any one of these aforementioned substituents.

The term “alkylaryl” used herein alone or as part of another group, refers to, in some embodiments, to an alkyl group as defined above, which is substituted by an aryl as defined herein.

The term “aryl” used herein alone or as part of another group denotes an aromatic ring system containing from 6-14 ring carbon atoms. The aryl ring can be a monocyclic, bicyclic, tricyclic and the like. Non-limiting examples of aryl groups are phenyl, naphthyl including 1-naphthyl and 2-naphthyl, and the like. The aryl group can be unsubstituted or substituted through available carbon atoms with one or more groups such as halogen, hydroxy, alkoxy, aryloxy, alkylaryloxy, heteroaryloxy, oxo, cycloalkyl, phenyl, heteroaryls, heterocyclyl, naphthyl, amino, alkylamino, arylamino, heteroarylamino, dialkylamino, diarylamino, alkylarylamino, alkylheteroarylamino, arylheteroarylamino, acyl, acyloxy, nitro, carboxy, carbamoyl, carboxamide, cyano, sulfonyl, sulfonylamino, sulfinyl, sulfinylamino, thiol, alkylthio, arylthio, or alkylsulfonyl groups. Any substituents can be unsubstituted or further substituted with any one of these aforementioned substituents.

In some embodiments n is an integer between 4-13. In other embodiments, n is an integer between 4-6, 4-9, 6-13, 5-10, or any ranges between integers 4, 5, 6, 7, 8, 9, 10, 11, 12 or 13.

In some embodiments, Mₐ, M_{b} and M_{c} or M″ of the compound of Formula (I) or (Ia) are each independently selected from the group consisting of: Cr, Mn, Fe, Co, Ni, Cu, Zn, Al, Ga, Sn, Sb, In, Sc, Sr, Mg, Y, Yb, Ba and Ca. In some embodiments, Mₐ, M_{b} and M_{c} are different. In some embodiments, at least two of Mₐ, M_{b} and M_{c} are different. In some embodiments, at least one of Mₐ, M_{b} and M_{c} is Cr. In some embodiments, at least one of Mₐ, M_{b} and M_{c} is Mn. In some embodiments, at least one of Mₐ, M_{b} and M_{c} is Fe. In some embodiments, at least one of Mₐ, M_{b} and M_{c} is Co. In some embodiments, at least one of Mₐ, M_{b} and M_{c} is Ni. In some embodiments, at least one of Mₐ, M_{b} and M_{c} is Cu. In some embodiments, at least one of Mₐ, M_{b} and M_{c} is Zn. In some embodiments, at least one of Mₐ, M_{b} and M_{c} is Al. In some embodiments, at least one of Mₐ, M_{b} and M_{c} is Ga. In some embodiments, at least one of Mₐ, M_{b} and M_{c} is Sn. In some embodiments, at least one of Mₐ, M_{b} and M_{c} is Sb. In some embodiments, at least one of Mₐ, M_{b} and M_{c} is In. In some embodiments, at least one of Mₐ, M_{b} and M_{c} is Sc. In some embodiments, at least one of Mₐ, M_{b} and M_{c} is Sr. In some embodiments, at least one of Mₐ, M_{b} and M_{c} is Mg. In some embodiments, at least one of Mₐ, M_{b} and M_{c} is Y. In some embodiments, at least one of Mₐ, M_{b} and M_{c} is Yb. In some embodiments, at least one of Mₐ, M_{b} and M_{c} is Ba. In some embodiments, at least one of Mₐ, M_{b} and M_{c} is Ca. In some embodiments, at least one of Mₐ, M_{b} and M_{c} is Sn, Al, Zn or Ga.

In some embodiments, the polyoxometalate of Formula (I) is (Q)ₙ[XCu₂M″LₐL_{b}L_{c}W₉O₃₇], wherein M″ is selected from the group consisting of Cr, Mn, Fe, Co, Ni, Cu, Zn, Al, Ga, Sn, Sb, In, Sc, Sr, Mg, Y, Yb, Ba and Ca. In one embodiment, M″ is Fe, Ni, Al, Ga, Sn or Zn. Each possibility represents a separate embodiment of this invention.

In some embodiments, the polyoxometalate of Formula (I) is (Q)ₙ[XCuFeZn LₐL_{b}L_{c}W₉O₃₇], (Q)ₙ[XCu₂FeLₐL_{b}L_{c}W₉O₃₇], (Q) [XCuFe₂LₐL_{b}L_{c}W₉O_{37],} (Q)ₙ[XCu₂NiLₐL_{b}L_{c}W₉O₃₇], (Q)ₙ[XCuNi₂LₐL_{b}L_{c}W₉O₃₇], (Q) [XCu₂ZnLₐL_{b}L_{c}W₉O_{37],} (Q)ₙ[XCu₂AlLₐL_{b}L_{c}W₉O₃₇], (Q)ₙ[XCu₂GaLₐL_{b}L_{c}W₉O₃₇], (Q)ₙ[XCu₂SnLₐL_{b}L_{c}W₉O₃₇], (Q)ₙ[XCu₂InLₐL_{b}L_{c}W₉O₃₇], (Q)ₙ[XCu₂SbLₐL_{b}L_{c}W₉O₃₇], (Q)ₙ[XCuFeNiLₐL_{b}L_{c}W₉O₃₇], (Q)ₙ[XCuFeAlLₐL_{b}L_{c}W₉O₃₇], (Q)ₙ[XCuFeGaLₐL_{b}L_{c}W₉O₃₇], (Q)ₙ[XCuFeSnLₐL_{b}L_{c}W₉O_{37],} (Q)ₙ[XCuNiZnLₐL_{b}L_{c}W₉O₃₇], (Q)ₙ[XCuNiAlLₐL_{b}L_{c}W₉O₃₇], (Q)ₙ[XCuCoZnLₐL_{b}L_{c}W₉O₃₇], (Q)ₙ[XCuCoAlLₐL_{b}L_{c}W₉O₃₇], (Q)ₙ[XCuMnZnLₐL_{b}L_{c}W₉O₃₇] or (Q)ₙ[XCuMnAlLₐL_{b}L_{c}W₉O₃₇]. Each possibility represents a separate embodiment of this invention.

In some embodiments, X of the polyoxometalate of Formula (I) is Si or P.

In some embodiments, Lₐ, L_{b} and L_{c} of the polyoxometalate of Formula (I) or (Ia) are each independently selected from the group consisting of H₂O, carboxylates, oxyanions, halides or pseudohalides, carbonate, bicarbonate or absent. In other embodiments, Lₐ, L_{b} and L_{c} of the polyoxometalate of Formula (I) are each independently H₂O. In other embodiments, Lₐ, L_{b} and L_{c} of the polyoxometalate of Formula (I) are each independently carboxylates. In other embodiments, Lₐ, L_{b} and L_{c} of the polyoxometalate of Formula (I) are each independently oxyanions. In other embodiments, Lₐ, L_{b} and L_{c} of the polyoxometalate of Formula (I) are each independently halides. In other embodiments, Lₐ, L_{b} and L_{c} of the polyoxometalate of Formula (I) are each independently pseudohalides. In other embodiments, Lₐ, L_{b} and L_{c} of the polyoxometalate of Formula (I) are each independently carbonate. In other embodiments, Lₐ, L_{b} and L_{c} of the polyoxometalate of Formula (I) are each independently bicarbonate. In other or absent.

In some embodiments, the polyoxometalate of Formula (I) is (Q)₉[SiCu₂Fe(H₂O)₃W₉O₃₇], (Q)₈[SiCuFe₂(H₂O)₃W₉O₃₇], (Q)₁₀[SiCu₂Ni(H₂O)₃W₉O₃₇], (Q)₁₀[SiCuNi₂(H₂O)₃W₉O_{37],} (Q)₉[SiCuFeNi(H₂O)₃W₉O₃₇], (Q)₈[SiFe₂Al(H₂O)₃W₉O₃₇], (Q)₉[SiFeGa₂(H₂O)₃W₉O_{37],} (Q)₁₀[SiCu₂Zn(H₂O)₃W₉O₃₇], (Q)₉[SiCu₂Al(H₂O)₃W₉O₃₇], (Q)₉[SiCu₂Ga(H₂O)₃W₉O_{37],} (Q)₈[SiCu₂Sn(H₂O)₃W₉O₃₇], (Q)₉SiCuFeZn(H₂O)₃W₉O₃₇], (Q)₈[SiCuFeAl(H₂O)₃W₉O_{37],} (Q)₈[SiCuFeGa(H₂O)₃W₉O₃₇], (Q)₇[SiCuFeSn(H₂O)₃W₉O₃₇], (Q)₁₀[SiCuNiZn(H₂O)₃W₉O₃₇] or (Q)₉[SiCuNiAl(H₂O)₃W₉O₃₇]. Each possibility represents a separate embodiment of this invention.

### Methods of Use

In one further embodiment, this invention provides a method for the reduction of carbon dioxide to carbon monoxide, formate salt or formic acid, formaldehyde, methanol, ethane, ethylene, ethanol or any combination thereof, comprising contacting the carbon dioxide with a polyoxometalate compound represented by formula (I):

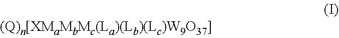

or a solvate thereof,
wherein,
X is P, Si, As, Ge, Ga, B, or Al;
Mₐ, M_{b} and M_{c} are each independently selected from the group consisting of: Cr, Mn, Fe, Co, Ni, Cu, Zn, Al, Ga, Sn, Sb, In, Sc, Sr, Mg, Y, Yb, Ba and Ca;
Lₐ, L_{b} and L_{c} are each independently selected from the group consisting of: H₂O, carboxylates, oxyanions, halides or pseudohalides, carbonate, bicarbonate or absent;
Q is a cation such as a proton, an alkali metal cation, an alkaline earth metal cation, a lanthanide cation, a nitrogen centered cation or a phosphorous centered cation or any combination thereof;
n is an integer between 4-13;
and wherein the reaction is conducted in an electrochemical cell comprising: a cathode, an anode, optionally a reference electrode, optionally a membrane; and the polyoxometalate compound of Formula (I) as the catalyst for the reduction of carbon dioxide.

In some embodiments, the methods for the reduction of carbon dioxide provided herein comprises contacting the carbon dioxide with a polyoxometalate compound represented by formula (I), wherein Mₐ, M_{b} and M_{c} are each independently selected from the group consisting of: Cr, Mn, Fe, Co, Ni, Cu, Zn, Al, Ga, Sn, Sb, In, Sc, Sr, Mg, Y, Yb, Ba and Ca and at least one of Mₐ, M_{b} and M_{c} is Sn, Al, Zn or Ga. In other embodiments, Mₐ, M_{b} and M_{c} are each independently selected from the group consisting of: Cr, Mn, Fe, Co, Ni, Cu, Zn, Al, Ga, Sn, Sb, In, Sc, Sr, Mg, Y, Yb, Ba and Ca and at least two of Mₐ, M_{b} and M_{c} are different. In other embodiments, Mₐ, M_{b} and M_{c} are each independently selected from the group consisting of: Cr, Mn, Fe, Co, Ni, Cu, Zn, Al, Ga, Sn, Sb, In, Sc, Sr, Mg, Y, Yb, Ba and Ca and Mₐ, M_{b} and M_{c} are different.

In some embodiments, the methods for the reduction of carbon dioxide provided herein is directed to reduction of carbon dioxide to carbon monoxide. In some embodiments, the reduction of carbon dioxide provided herein is directed to reduction of carbon dioxide to formate salt or formic acid. In some embodiments, the reduction of carbon dioxide provided herein is directed to reduction of carbon dioxide to formaldehyde. In some embodiments, the reduction of carbon dioxide provided herein is directed to reduction of carbon dioxide to methanol. In some embodiments, the reduction of carbon dioxide provided herein is directed to reduction of carbon dioxide to ethane, ethylene or ethanol or any combination thereof.

In some embodiments, the electrochemical cell of this invention comprises a working (cathode), a counter (anode) and optionally a reference electrode. In one embodiment, the electrochemical cell of this invention comprises a working, a counter and a reference electrode. In one embodiment, any material and shape of an electrode known in the art can be used in this invention.

In one embodiment the electrochemical is a gas diffusion electrolyser.

In some embodiments, the electrolyte of the electrochemical cell is any electrolyte as known in the art.

In some embodiments the electrolyte is Q-Z wherein Z is and oxyanion, halide, peusdo halide, PF₆⁻ or BF₄⁻ and Q is as defined in formula (I).

In some embodiments, there is a solvent in the electrochemical cell wherein the solvent is any solvent known in the art.

In some embodiments the solvent is water at basic, neutral or acidic pH.

In some embodiments the solvent is an organic solvent or combinations of organic solvents. Non limiting examples of organic solvents include acetonitrile, glutaronitrile, adiponitrile, dimethyformamide, dimethylacetamide, dimethylsulfone, dimethylsulfoxide, tetrahydrofuran, glyme, diglyme, ethylene glycol oligomers, ethylene glycol polymers, mono alkylated ethylene glycol oligomers, mono alkylated ethylene glycol polymers, di alkylated ethylene glycol oligomers, di alkylated ethylene glycol polymers or combination thereof.

In some embodiments, the cathode of the electrochemical cell is carbon, such as a carbon disc, a carbon rod, carbon cloth or carbon paper.

In some embodiments, the cathode of the electrochemical cell is metal, such as titanium, iron or copper.

In some embodiments, the anode of the electrochemical cell is a Pt wire, carbon, iridium oxide, ruthenium oxide, iron, nickel, iron-nickel combinations, or cobalt containing compounds.

In some embodiments, the membrane of the electrochemical cell is any membrane as known in the art.

In some embodiments the membrane is anionic, in some embodiments is Nafion, in some embodiments the membrane is a ceramic material such a zirconia and alumina, in some embodiments the membrane is a porous organic polymer.

In some embodiments, the applied potential of the electrochemical cell is between −3.5 to 0.0 V, −3.0 to 0.0 V, −2.5 to 0.0 V, −2.0 to 0.0 V or −1.5 to 0.0 V vs Fc/Fc⁺. In one specific embodiment, the applied potential is −2.5 V or −1.5 V vs Fc/Fc⁺.

In another embodiment, the following setup is utilized: a glassy carbon disc (d=3 mm) as a working electrode, a 15 mm Pt wire separated by a glass frit as a counter electrode and Fc/Fc⁺ as a reference electrode. In another embodiment, the following setup is utilized: a titanium metal working electrode, a carbon cloth counter electrode and a Nafion membrane. Each possibility represents a separate embodiment of the invention.

In one embodiment, the electrochemical cell comprises a cathode, an anode, the polyoxometalate compound (the compound of Formula (I)) and an electrolyte.

In one embodiment, the electrochemical cell comprises a cathode, an anode, the polyoxometalate compound, a reference electrode and an electrolyte.

In one embodiment, the electrocatalytic reaction is carried out in an undivided cell in an organic solvent.

In one embodiment, the electrocatalytic reaction is carried out in a divided cell configuration with a polymer membrane electrolyte separating the anode and cathode compartments.

In one embodiment, the electrocatalytic reaction is carried out in a divided cell configuration in an organic solvent, an electrolyte with a polymer membrane electrolyte separating the anode and cathode compartments.

In one embodiment, the electrocatalytic reaction is carried out in a flow cell membrane electrolyzer where the polyoxometalate is dissolved in a solvent.

In one embodiment, the electrocatalytic reaction is carried out in a gas diffusion electrolyzer.

In one embodiment, the electrochemical cell of this invention comprises a cathode and an anode, and a polyoxometalate compound (represented by formula (I)). In one embodiment, the compound is used in a solid form. In one embodiment, the compound is dissolved in a solution. In one embodiment, the solution comprises a solvent and a solute, the solute being the polyoxometalate compound of this invention and optionally an electrolyte. In one embodiment, the solvent is acetonitrile. In one embodiment, the concentration of the polyoxometalate compound ranges between 0.1 to 5 mM, 0.1 to 1 mM, 0.1 to 2 mM or 1 to 5 mM. In another embodiment, the compound's concentration is 2 mM. In one embodiment, the electrolyte concentration in the solution is between 0.01 to 1 M or 0.05-1M. In another embodiment, the electrolyte's concentration is 0.1M. Each possibility represents a separate embodiment of the invention.

In one embodiment, the electrolyte further comprises additives, stabilizers, salts, ions, or a combination thereof. In one embodiment, the pH of the electrolyte is adjusted. In one embodiment, the pH of the solution comprising water and the compound ranges between 0-14. In one embodiment, the pH value of the solution is acidic. In one embodiment, the pH of the solution is basic. In one embodiment, the solution pH ranges between 6-8, between 5-9, between 4-10, 3-11, 2-12 or 1-13. Each possibility represents a separate embodiment of the invention.

In one embodiment, the method of this invention comprises contacting the polyoxometalate compound of this invention with carbon dioxide in an electrochemical cell for a period of between 0.1-72 hours. In another embodiment, for 0.1-2 hours. In another embodiment, for 2-5 hours. In another embodiment, for 5-10 hours. In another embodiment, for 10-15 hours. In another embodiment, for 10-20 hours. In another embodiment, for 15-30 hours. In another embodiment, the step is conducted for 20-50 hours. In another embodiment, for 25-72 hours. In another embodiment, for 1 hour. In another embodiment, for 15 hours. Each possibility represents a separate embodiment of the invention.

Preparation of the Compounds of this Invention

In one embodiment, the anion of polyoxometalate of formula (I) of this invention is prepared by the following methods. In one embodiment, [XMₐM_{b}M_{c}(LₐL_{b}L_{c})W₉O₃₇]ⁿ⁻ (the anion of formula (I)) is prepared by reacting a water soluble α- or β-[XW₉O₃₄]⁹⁻ anion in water with a mixture of up to three salts wherein each salt is represented by M_{w}L_{y}·zH₂O or with the compound MₐM_{b}M_{c}(Lₐ)ₙₐ(L_{b})_{nb}(L_{c})_{nc} (Formula (Ia); see further embodiments thereof below) to yield the anion [XMₐM_{b}M_{c}(LₐL_{b}L_{c})W₉O₃₇]ⁿ⁻, where X, Mₐ-M_{c}, Lₐ-L_{c} and n are as described hereinabove, w and y are each independently an integer between 1-5, z is an integer between 0 and 10, na, nb and nc are each independently an integer between 1-5, M is Cr, Mn, Fe, Co, Ni, Cu, Zn, Al, Ga, Sc, Sr, Mg, Y, Ba or Ca and L is a carboxylate, an oxyanion, a halide or a pseudohalide, a carbonate, a bicarbonate or absent.

In one embodiment, this invention provides a method of preparing [XMₐM_{b}M_{c}(LₐL_{b}L_{c})W₉O₃₇]ⁿ⁻, comprising reacting a water soluble α- or β-[XW₉O₃₄]⁹⁻ anion in water with a mixture of up to three salts wherein each salt is represented by M_{w}L_{y}·zH₂O or with MₐM_{b}M_{c}(Lₐ)ₙₐ(L_{b})_{nb}(L_{c})_{nc}, thereby providing [XMₐM_{b}M_{c}(LₐL_{b}L_{c})W₉O₃₇]ⁿ⁻, where X, Mₐ-M_{c}, Lₐ-L_{c} and n are as described hereinabove, w and y are each independently an integer between 1-5, z is an integer between 0 and 10, na, nb and nc are each independently an integer between 1-5, M is Cr, Mn, Fe, Co, Ni, Cu, Zn, Al, Ga, Sc, Sr, Mg, Y, Ba or Ca and L is a carboxylate, an oxyanion, a halide or a pseudohalide, a carbonate, a bicarbonate or absent.

The Following Provides Specific Methods for the Preparation of Q′ₙ[XMₐM_{b}M_{c}(LₐL_{b}L_{c})W₉O_{37]}

In one embodiment, Na₉[β-[SiW₉O₃₄] is reacted in water with a mixture up to three salts wherein each salt is represented by M_{w}L_{y}·zH₂O to yield Q′ₙ[SiMₐM_{b}M_{c}(LₐL_{b}L_{c})W₉O₃₇] where w, y, z, M, Mₐ-M_{c}, Lₐ-L_{c} and n are as described hereinabove; Q′ is a cation such as a proton, an alkali metal cation, or a combination thereof and L is a carboxylate, an oxyanion, a halide or a pseudohalide, a carbonate, a bicarbonate or absent.

In one embodiment, Na₉[α-[SiW₉O₃₄] is reacted in water with a mixture of up to three salts wherein each salt is represented by M_{w}L_{y}·zH₂O to yield Q′ₙ[SiMₐM_{b}M_{c}(LₐL_{b}L_{c})W₉O₃₇] where w, y, z, M, Mₐ-M_{c}, Lₐ-L_{c} and n are as described hereinabove; Q′ is a cation such as a proton, an alkali metal cation, or a combination thereof; and L is a carboxylate, an oxyanion, a halide or a pseudohalide, a carbonate, a bicarbonate or absent.

In one embodiment, Na₉[PW₉O₃₄] is reacted in water with a mixture of up to three salts wherein each salt is represented by M_{w}L_{y}·zH₂O to yield Q′ₙ[PMₐM_{b}M_{c}(LₐL_{b}L_{c})W₉O₃₇] where w, y, z, M, Mₐ-M_{c}, Lₐ-L_{c} and n are as described hereinabove; Q′ is a cation such as a proton, an alkali metal cation, or a combination thereof; and L is a carboxylate, an oxyanion, a halide or a pseudohalide, a carbonate, a bicarbonate or absent.

In one embodiment, Na₉[β-[SiW₉O₃₄] is reacted in water with the compound MₐM_{b}M_{c}(Lₐ)ₙₐ(L_{b})_{nb}(L_{c})ne to yield Q′ₙ[SiMₐM_{b}M_{c}(LₐL_{b}L_{c})W₉O₃₇] where y, Q′, Mₐ-M_{c}, Lₐ-Le and n are as described hereinabove. In another embodiment, na+nb+nc=9.

In one embodiment, Na₉[α-[SiW₉O₃₄] is reacted in water with the compound MₐM_{b}M_{c}(Lₐ)ₙₐ(L_{b})_{nb}(L_{c})_{nc} to yield Q′ₙ[SiMₐM_{b}M_{c}(LₐL_{b}L_{c})W₉O₃₇] where y, Q′, Mₐ-M_{c}, Lₐ-L_{c} and n are as described hereinabove. In another embodiment, na+nb+nc=9.

In one embodiment, Na₉[PW₉O₃₄] is reacted in water with the compound MₐM_{b}M_{c}(Lₐ)ₙₐ(L_{b})_{nb}(L_{c})_{nc} to yield Q′ₙ[PMₐM_{b}M_{c}(LₐL_{b}L_{c})W₉O₃₇] where w, y, Q′, Mₐ-M_{c}, Lₐ-L_{c} and n are as described hereinabove. In another embodiment, na+nb+nc=9.

The following provides specific methods for the preparation of XMₐM_{b}M_{c}(LₐL_{b}L_{c})W₉O₃₇]ⁿ⁻:

In one embodiment, [XMₐM_{b}M_{c}(LₐL_{b}L_{c})W₉O₃₇]ⁿ⁻ is prepared by reacting a water soluble α- or β-[XW₉O₃₄]⁹⁻ anion in water with a mixture of up to three salts wherein each salt is represented by M_{w}L_{y}·zH₂O to yield the anion [XMₐM_{b}M_{c}(LₐL_{b}L_{c})W₉O₃₇]n−, where w, y, z, X, M, Mₐ-M_{c}, Lₐ-L_{c} and n are as described hereinabove; and L is a carboxylate, an oxyanion, a halide or a pseudohalide, a carbonate, a bicarbonate or absent.

In one embodiment, [XMₐM_{b}M_{c}(LₐL_{b}L_{c})W₉O₃₇]ⁿ⁻ is prepared by reacting a water soluble α- or β-[XW₉O₃₄]⁹⁻ anion in water with the compound MₐM_{b}M_{c}(Lₐ)ₙₐ(L_{b})_{nb}(L_{c})_{nc} to yield the anion [XMₐM_{b}M_{c}(LₐL_{b}L_{c})W₉O₃₇]ⁿ⁻ where y, X, Mₐ-M_{c}, Lₐ-Le and n are as described hereinabove. In another embodiment, na+nb+nc=9.

The following provides specific methods for cation exchange from Q′ to Q of XMₐM_{b}M_{c}(LₐL_{b}L_{c})W₉O₃₇]ⁿ⁻

In one embodiment, (Q)ₙ[XMₐM_{b}M_{c}(Lₐ)(L_{b})(L_{c})W₉O₃₇], wherein Q is selected from the group consisting of: an alkaline earth metal salt, a lanthanide salt, a quaternary ammonium salt or a quaternary phosphonium salt and any combination thereof, is prepared by reacting (Q′)ₙ[XMₐM_{b}M_{c}(Lₐ)(L_{b})(L_{c})W₉O₃₇] with an alkaline earth metal salt, a lanthanide salt, a quaternary ammonium salt or a quaternary phosphonium salt including combinations thereof, where Q′, X, Mₐ-M_{c}, Lₐ-L_{c} and n are as described hereinabove.

In one embodiment, Qₙ[SiMₐM_{b}M_{c}(LₐL_{b}L_{c})W₉O₃₇], wherein Q is selected from the group consisting of: an alkaline earth metal salt, a lanthanide salt, a quaternary ammonium salt or a quaternary phosphonium salt and any combination thereof, is prepared by reacting Q′ₙ[SiMₐM_{b}M_{c}(LₐL_{b}L_{c})W₉O₃₇] with an alkaline earth metal salt, a lanthanide salt, a quaternary ammonium salt or a quaternary phosphonium salt including combinations thereof, where Q′, Mₐ-M_{c}, Lₐ-L_{c}, n are as described hereinabove.

In one embodiment, Qₙ[PMₐM_{b}M_{c}(LₐL_{b}L_{c})W₉O₃₇], wherein Q is selected from the group consisting of: an alkaline earth metal salt, a lanthanide salt, a quaternary ammonium salt or a quaternary phosphonium salt and any combination thereof, is prepared by reacting Q′ₙ[PMₐM_{b}M_{c}(LₐL_{b}L_{c})W₉O₃₇] with an alkaline earth metal salt, a lanthanide salt, a quaternary ammonium salt or a quaternary phosphonium salt including combinations thereof, where Q′, Mₐ-M_{c}, Lₐ-L_{c} and n are as described hereinabove.

The MₐM_{b}M_{c}(Lₐ)ₙₐ(L_{b})_{nb}(L_{c})_{nc} Compounds

In one embodiment, this invention provides a mixed metal salt compound represented by Formula (Ia) anion:

MₐM_{b}M_{c}(Lₐ)ₙₐ(L_{b})_{nb}(L_{c})_{nc} (Ia)
wherein
Mₐ, M_{b} and M_{c} are each independently selected from the group consisting of: Cr, Mn, Fe, Co, Ni, Cu, Zn, Al, Ga, Sn, Sb, In, Sc, Sr, Mg, Y, Yb, Ba and Ca;
Lₐ, L_{b} and L_{c} are each independently selected from the group consisting of: H₂O, carboxylates, oxyanions, halides or pseudohalides, carbonate, bicarbonate or absent; and
na, nb and nc are each independently an integer between 1-5;
wherein the cation is Qₙ and
Q is a cation such as a proton, an alkali metal cation, an alkaline earth metal cation, a lanthanide cation, a nitrogen centered cation or a phosphorous centered cation or any combination thereof;
n is an integer between 4-13.

In other embodiments, Mₐ, M_{b} and M_{c} are each independently selected from the group consisting of: Cr, Mn, Fe, Co, Ni, Cu, Zn, Al, Ga, Sn, Sb, In, Sc, Sr, Mg, Y, Yb, Ba and Ca and at least one of Mₐ, M_{b} and M_{c} is Sn, Al, Zn or Ga. In other embodiments, Mₐ, M_{b} and M_{c} are each independently selected from the group consisting of: Cr, Mn, Fe, Co, Ni, Cu, Zn, Al, Ga, Sn, Sb, In, Sc, Sr, Mg, Y, Yb, Ba and Ca and at least two of Mₐ, M_{b} and M_{c} are different. In other embodiments, Mₐ, M_{b} and M_{c} are each independently selected from the group consisting of: Cr, Mn, Fe, Co, Ni, Cu, Zn, Al, Ga, Sn, Sb, In, Sc, Sr, Mg, Y, Yb, Ba and Ca and Mₐ, M_{b} and M_{c} are different (representing three different metal selected from the group above).

In another embodiment, the sum of na, nb and nc (i.e. na+nb+nc) is between 3-15, 3-5, 3-10, 10-15, 12-15, 5-15, 7-12 or 8-11. In another embodiment, na+nb+nc=9.

In one embodiment, Formula (Ia) is represented by: CuFeZn(Lₐ)ₙₐ(L_{b})_{nb}(L_{c})_{nc}, Cu₂Fe(Lₐ)ₙₐ(L_{b})_{nb}(L_{c})_{nc}, CuFe₂(Lₐ)ₙₐ(L_{b})_{nb}(L_{c})_{nc}, Cu₂Ni(Lₐ)ₙₐ(L_{b})_{nb}(L_{c})_{nc}, CuNi₂(Lₐ)ₙₐ(L_{b})_{nb}(L_{c})_{nc}, Cu₂Zn(Lₐ)ₙₐ(L_{b})_{nb}(L_{c})_{nc}, Cu₂Ga(Lₐ)ₙₐ(L_{b})_{nb}(L_{c})_{nc}, Cu₂Al(Lₐ)ₙₐ(L_{b})_{nb}(L_{c})_{nc}, Cu₂SC(Lₐ)ₙₐ(L_{b})_{nb}(L_{c})_{nc}, Cu₂Mg(Lₐ)ₙₐ(L_{b})_{nb}(L_{c})_{nc}, Fe₂Ni(Lₐ)ₙₐ(L_{b})_{nb}(L_{c})_{nc}, FeNi₂(Lₐ)ₙₐ(L_{b})_{nb}(L_{c})_{nc}, CuFeNi(Lₐ)ₙₐ(L_{b})_{nb}(L_{c})_{nc}, CuFeAl(Lₐ)ₙₐ(L_{b})_{nb}(L_{c})_{nc}, CuNiZn(Lₐ)ₙₐ(L_{b})_{nb}(L_{c})_{nc}, CUNiAl(Lₐ)ₙₐ(L_{b})_{nb}(L_{c})_{nc}, CuCoZn(Lₐ)ₙₐ(L_{b})_{nb}(L_{c})_{nc}CuCoAl(Lₐ)ₙₐ(L_{b})_{nb}(L_{c})_{nc}CuMnZn(Lₐ)ₙₐ(L_{b})_{nb}(L_{c})_{nc}, or CuMnAl(Lₐ)ₙₐ(L_{b})_{nb}(L_{c})_{nc}.

In one embodiment, Formula (Ia) is represented by: [Cu₂Fe(MeCOO)₆(H₂O)₃], [Cu₂Ni(MeCOO)₆(H₂O)₃], [Cu₂Zn(MeCOO)₆(H₂O)₃], [Cu₂Ga(MeCOO)₆(H₂O)₃], [Cu₂Al(MeCOO)₆(H₂O)₃], [Cu₂Sc(MeCOO)₆(H₂O)₃], [Cu₂Mg(MeCOO)₆(H₂O)₃], [CuFeNi(MeCOO)₆(H₂O)₃], [CuFeZn(MeCOO)₆(H₂O)₃], [CuFeAl(MeCOO)₆(H₂O)₃], [CuNiZn(MeCOO)₆(H₂O)₃] or [CuNiAl(MeCOO)₆(H₂O)₃]. Each possibility represents a separate embodiment of the invention.

In one embodiment, MₐM_{b}M_{c}(Lₐ)ₙₐ(L_{b})_{nb}(L_{c})_{nc} (Ia) is prepared by reacting up to three salts such as M_{w}L_{y}·zH₂O, and isolating the obtained salt as MₐM_{b}M_{c}(Lₐ)ₙₐ(L_{b})_{nb}(L_{c})_{nc} (Ia), wherein w and y are each independently an integer between 1-5, z is an integer between 0 and 10, Lₐ, L_{b}, L_{c} is each independently a carboxylate, an oxyanion, a halide or a pseudohalide, a carbonate, a bicarbonate or absent and Mₐ, M_{b}, M_{c} is each independently Cr, Mn, Fe, Co, Ni, Cu, Zn, Al, Ga, Sn, Sb, In, Sc, Sr, Mg, Y, Yb, Ba or Ca.

In one embodiment, this invention provides a method of preparing MₐM_{b}M_{c}(Lₐ)ₙₐ(L_{b})_{nb}(L_{c})_{nc} (Ia), comprising mixing a solution(s) of up to three salts wherein each salt is represented by M_{w}L_{y}·zH₂O, and isolating the obtained salt as MₐM_{b}M_{c}(Lₐ)ₙₐ(L_{b})_{nb}(L_{c})_{nc} (Ia), wherein w, y, z, Lₐ, L_{b}, L_{c} and Mₐ, M_{b}, M_{c} are described hereinabove.

In another embodiment, the solutions are aqueous or any other as known in the art. In another embodiment, the solutions of the salts are filtered prior to the mixing thereof. In other embodiments, the isolation of MₐM_{b}M_{c}(Lₐ)ₙₐ(Lo)_{nb}(L_{c})_{nc} (Ia) comprises any isolation step as known in the art (non-limiting examples include evaporation, precipitation/crystallization, extraction, sublimation etc.). In another embodiment, the isolation comprises vacuum evaporation of the mixture obtained by mixing the M_{w}L_{y}·zH₂O salts. Each possibility represents a separate embodiment of the invention.

### SPECIFIC EMBODIMENTS

In one embodiment, this invention provides a method of reducing carbon dioxide to carbon monoxide by reacting polyoxometalate compound (Q)ₙ[XCu₂M″LₐL_{b}L_{c}W₉O₃₇] or solvates thereof with carbon dioxide, wherein the reaction is conducted in an electrochemical cell and where M″ is Cr, Mn, Fe, Co, Ni, Cu, Zn, Al, Ga, Sn, Sb, In, Sc, Sr, Mg, Y, Yb, Ba and Ca.

In one embodiment, this invention provides a method of reducing carbon dioxide to carbon monoxide by reacting polyoxometalate compound (Q)ₙ[SiCu₂M″LₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[PCu₂M″LₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[XCuFeZnLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[SiCuFeZnLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[PCuFeZnLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[XCuFeAlLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[SiCuFeAlLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[PCuFeAlLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[XCuFeGaLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[SiCuFeGaLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[PCuFeGaLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[XCuFeSnLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[SiCuFeSnLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[PCuFeSnLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[XCuNiZnLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[SiCuNiZnLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[PCuNiZnLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[XCuNiAlLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[SiCuNiAlLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[PCuNiAlLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[XCuNiGaLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[SiCuNiGaLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[PCuNiGaLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[XCuCoZnLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[SiCuCoZnLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[PCuCoZnLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[XCuCoAlLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[SiCuCoAlLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[PCuCoAlLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[XCuMnZnLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[SiCuMnZnLₐL_{b}L_{c}W₉O₃₇] or solvates thereof with carbon dioxide, wherein the reaction conducted in an electrochemical cell.

In one embodiment this invention provides a method of reducing carbon dioxide to carbon monoxide by reacting polyoxometalate compound (Q)ₙ[PCuMnZnLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[XCuMnAlLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[SiCuMnAlLₐL_{b}L_{c}W₉O₃₇] or solvates thereof with carbon dioxide, wherein the reaction is conducted in an electrochemical cell.

In one embodiment this invention provides a method of reducing carbon dioxide to carbon monoxide by reacting polyoxometalate compound (Q)ₙ[PCuMnAlLₐL_{b}L_{c}W₉O₃₇] or solvates thereof with carbon dioxide, wherein the reaction is conducted in an electrochemical cell.

In some embodiments, within the above specific embodiments, X, Q, Lₐ-L_{c} and n are as described hereinabove for the compound of formula (I).

### EXAMPLES

### Example 1

Synthesis of {SiW₉O₃₇[Cu₂Ga(L)]₃}⁹⁻ as a cesium salt, where L=H₂O or OAc⁻:

A solution of sodium acetate trihydrate (0.32 mol) in water (70 mL) was added to a filtered, stirred solution of copper(II) nitrate trihydrate (0.02 mol) and gallium(III) nitrate hydrate (0.01 mol) in water (70 mL). This resulted in a blue solution, which was evaporated and dried under vacuum to yield [Cu₂Ga(MeCOO)₆(H₂O)₃]. To a solution of [Cu₂Ga(MeCOO)₆(H₂O)₃] (1.75 mmol) in water (15 mL), Na₉[β-SiW₉O₃₄H]·23H₂O (1.75 mmol, prepared according to: G. Herve and A. Teze, Study of alpha-and. beta.-enneatungstosilicates and-germanates Inorg. Chem., 1977, 16, 2115-2117) dissolved in NaOAc/HOAc solution (pH 6) was added in small amounts with vigorous stirring, and was heated to 50° C. for 1 hour. After adding CsCl (0.33 g/ml) solution at room temperature, this produced a light green precipitate of Cs₉[SiW₉O₃₇{Cu₂Ga(L)₃}]. The compound was characterized by Infra-red and High Resolution Mass Spectroscopy, Yield—48%.

### Example 2

Synthesis of {SiW₉O₃₇[Cu₂Zn(L)]₃}^{10—} as a cesium salt, where L=H₂O or OAc⁻:

A solution of sodium acetate trihydrate (0.32 mol) in water (70 mL) was added to a filtered, stirred solution of copper(II) nitrate trihydrate (0.02 mol) and zinc(II) nitrate hexahydrate (0.01 mol) in water (70 mL). This resulted in a blue solution, which was evaporated and dried under vacuum to yield [Cu₂Zn(MeCOO)₆(H₂O)₃]. To a solution of [Cu₂Zn(MeCOO)₆(H₂O)₃] (1.75 mmol) in water (15 mL), Na₉[β-SiW₉O₃₄H]·23H₂O (1.75 mmol, prepared according to: G. Herve and A. Teze, Study of alpha-and. beta.-enneatungstosilicates and-germanates Inorg. Chem., 1977, 16, 2115-2117) dissolved in NaOAc/HOAc solution (pH 6) was added in small amounts with vigorous stirring, and was heated to 50° C. for 1 hour. After adding CsCl (0.33 g/ml) solution at room temperature, this produced a light green precipitate of Cs₁₀[SiW₉O₃₇{Cu₂Zn(L)₃}]. The compound was characterized by Infra-red and High Resolution Mass Spectroscopy, Yield—57%.

### Example 3

Synthesis of {SiW₉O₃₇[Cu₂Sn(L)]₃}⁸⁻ as a cesium salt, where L=H₂O or OAc:

A solution of sodium acetate trihydrate (0.32 mol) in water (70 mL) was added to a filtered, stirred solution of copper(II) nitrate trihydrate (0.02 mol) and tin(IV) acetate (0.01 mol) in water (70 mL). This resulted in a blue solution, which was evaporated and dried under vacuum to yield [Cu₂Zn(MeCOO)₆(H₂O)₃]. To a solution of [Cu₂Sn(MeCOO)₆(H₂O)₃] (1.75 mmol) in water (15 mL), Na₉[β-SiW₉O₃₄H]·23H₂O (1.75 mmol, prepared according to: G. Herve and A. Teze, Study of alpha-and. beta.-enneatungstosilicates and-germanates Inorg. Chem., 1977, 16, 2115-2117) dissolved in NaOAc/HOAc solution (pH 6) was added in small amounts with vigorous stirring, and was heated to 50° C. for 1 hour. After adding CsCl (0.33 g/ml) solution at room temperature, this produced a light green precipitate of Cs₈[SiW₉O₃₇{Cu₂Sn(L)₃}]. The compound was characterized by Infra-red and High Resolution Mass Spectroscopy, Yield—49%.

### Example 4

Synthesis of {SiW₉O₃₇[Cu₂Al(L)]₃}⁹⁻ as a cesium salt, where L=H₂O or OAc⁻:

A solution of sodium acetate trihydrate (0.32 mol) in water (70 mL) was added to a filtered, stirred solution of copper(II) nitrate trihydrate (0.02 mol) and aluminium(III) nitrate nonahydrate (0.01 mol) in water (70 mL). This resulted in a blue solution, which was evaporated and dried under vacuum to yield [Cu₂Al(MeCOO)₆(H₂O)₃] To a solution of [Cu₂Al(MeCOO)₆(H₂O)₃] (1.75 mmol) in water (15 mL), Na₉[β-SiW₉O₃H]·23H₂O (1.75 mmol, prepared according to: G. Herve and A. Teze, Study of alpha-and. beta.-enneatungstosilicates and-germanates Inorg. Chem., 1977, 16, 2115-2117) dissolved in NaOAc/HOAc solution (pH 6) was added in small amounts with vigorous stirring, and was heated to 50° C. for 1 hour. After adding CsCl (0.33 g/ml) solution at room temperature, this produced a light green precipitate of Cs₉[SiW₉O₃₇{Cu₂Al(L)₃}]. The compound was characterized by Infra-red and High Resolution Mass Spectroscopy, Yield—51%.

### Example 5

Synthesis of {SiW₉O₃₇[Cu₂Sc(L)]₃}⁹⁻ as a cesium salt, where L=H₂O or OAc⁻:

A solution of sodium acetate trihydrate (0.32 mol) in water (70 mL) was added to a filtered, stirred solution of copper(II) nitrate trihydrate (0.02 mol) and scadium(III) nitrate hexahydrate (0.01 mol) in water (70 mL). This resulted in a blue solution, which was evaporated and dried under vacuum to yield [Cu₂Sc(MeCOO)₆(H₂O)₃] To a solution of [Cu₂Sc(MeCOO)₆(H₂O)₃] (1.75 mmol) in water (15 mL), Na₉[β-SiW₉O₃₄H]·23H₂O (1.75 mmol, prepared according to: G. Herve and A. Teze, Study of alpha-and. beta.-enneatungstosilicates and-germanates Inorg. Chem., 1977, 16, 2115-2117) dissolved in NaOAc/HOAc solution (pH 6) was added in small amounts with vigorous stirring, and was heated to 50° C. for 1 hour. After adding CsCl (0.33 g/ml) solution at room temperature, this produced a light green precipitate of Cs₉[SiW₉O₃₇{Cu₂Sc(L)₃}]. The compound was characterized by Infra-red and High Resolution Mass Spectroscopy, Yield—36%.

### Example 6

Synthesis of {SiW₉O₃₇[Cu₂Mg(L)]₃}¹⁰⁻ as a cesium salt, where L=H₂O or OAc⁻:

A solution of sodium acetate trihydrate (0.32 mol) in water (70 mL) was added to a filtered, stirred solution of copper(II) nitrate trihydrate (0.02 mol) and magnesium (II) nitrate hexahydrate (0.01 mol) in water (70 mL). This resulted in a lightblue solution, which was evaporated and dried under vacuum to yield [Cu₂Mg(MeCOO)₆(H₂O)₃]. To a solution of [Cu₂Mg(MeCOO)₆(H₂O)₃] (1.75 mmol) in water (15 mL), Na₉[β-SiW₉O₃₄H]·23H₂O (1.75 mmol, prepared according to: G. Herve and A. Teze, Study of alpha-and. beta.-enneatungstosilicates and-germanates Inorg. Chem., 1977, 16, 2115-2117) dissolved in NaOAc/HOAc solution (pH 6) was added in small amounts with vigorous stirring, and was heated to 50° C. for 1 hour. After adding CsCl (0.33 g/ml) solution at room temperature, this produced a light green precipitate of Cs₁₀[SiW₉O₃₇{Cu₂Mg(L)₃}]. The compound was characterized by Infra-red and High Resolution Mass Spectroscopy, Yield—35%.

### Example 7

Synthesis of {SiW₉O₃₇[CuFeNi(L)]₃}⁹⁻ as a cesium salt, where L=H₂O or OAc⁻:

A solution of sodium acetate trihydrate (0.32 mol) in water (70 mL) was added to a filtered, stirred solution of copper(II) nitrate trihydrate (0.01 mol), iron(III) nitrate nonahydrate (0.01 mol) and nickel(II) nitrate hexahydrate (0.01 mol) in water (70 mL). This resulted in a yellow-green solution, which was evaporated and dried under vacuum to yield [CuFeNi(MeCOO)₆(H₂O)₃]. To a solution of [CuFeNi(MeCOO)₆(H₂O)₃] (1.75 mmol) in water (15 mL), Na₉[β-SiW₉O₃₄H]·23H₂O (1.75 mmol, prepared according to: G. Herve and A. Teze, Study of alpha-and. beta.-enneatungstosilicates and-germanates Inorg. Chem., 1977, 16, 2115-2117) dissolved in NaOAc/HOAc solution (pH 6) was added in small amounts with vigorous stirring, and was heated to 50° C. for 1 hour. After adding CsCl (0.33 g/mL) solution at room temperature, this produced a light yellow-green precipitate of Cs₉[SiW₉O₃₇{CuFeNi(L)₃}]. The compound was characterized by Infra-red and High Resolution Mass Spectroscopy, Yield—47%.

### Example 8

Synthesis of {SiW₉O₃₇[CuFeZn(L)]₃}⁹⁻ as a cesium salt, where L=H₂O or OAc⁻:

A solution of sodium acetate trihydrate (0.32 mol) in water (70 mL) was added to a filtered, stirred solution of copper(II) nitrate trihydrate (0.01 mol), iron(III) nitrate nonahydrate (0.01 mol) and zinc(II) nitrate hexahydrate (0.01 mol) in water (70 ml). This resulted in a brown solution, which was evaporated and dried under vacuum to yield [CuFeZn(MeCOO)₆(H₂O)_{3]}.

To a solution of [CuFeZn(MeCOO)₆(H₂O)₃] (1.75 mmol) in water (15 mL), Na₉[β-SiW₉O₃₄H]·23H₂O (1.75 mmol, prepared according to: G. Herve and A. Teze, Study of alpha-and. beta.-enneatungstosilicates and-germanates Inorg. Chem., 1977, 16, 2115-2117) dissolved in NaOAc/HOAc solution (pH 6) was added in small amounts with vigorous stirring, and was heated to 50° C. for 1 hour. After adding CsCl (0.33 g/mL) solution at room temperature, this produced a light yellow-green precipitate of Cs₉[SiW₉O₃₇{CuFeZn(L)₃}]. The compound was characterized by Infra-red and High Resolution Mass Spectroscopy, Yield—37%.

### Example 9

Synthesis of {SiW₉O₃₇[CuFeAl(L)]₃}⁸⁻ as cesium salt, where L=H₂O or OAc⁻:

A solution of sodium acetate trihydrate (0.32 mol) in water (70 mL) was added to a filtered, stirred solution of copper(II) nitrate trihydrate (0.01 mol), iron(III) nitrate nonahydrate (0.01 mol) and aluminium(III) nitrate nonahydrate (0.01 mol) in water (70 mL). This resulted in a green-brown solution, which was evaporated and dried under vacuum to yield [CuFeAl(MeCOO)₆(H₂O)₃]. To a solution of [CuFeAl(MeCOO)₆(H₂O)₃] (1.75 mmol) in water (15 mL), Na₉[β-SiW₉O₃₄H]·23H₂O (1.75 mmol, prepared according to: G. Herve and A. Teze, Study of alpha-and. beta.-enneatungstosilicates and-germanates Inorg. Chem., 1977, 16, 2115-2117) dissolved in NaOAc/HOAc solution (pH 6) was added in small amounts with vigorous stirring, and was heated to 50° C. for 1 hour. After adding CsCl (0.33 g/mL) solution at room temperature, this produced a yellow-green precipitate of Cs₈[SiW₉O₃₇{CuFeAl(L)₃}]. The compound was characterized by Infra-red and High Resolution Mass Spectroscopy, Yield—54%.

### Example 10

Synthesis of {SiW₉O₃₇[CuNiZn(L)]₃}⁻¹⁰ as cesium salts, where L=H₂O or OAc⁻:

A solution of sodium acetate trihydrate (0.32 mol) in water (70 mL) was added to a filtered, stirred solution of copper(II) nitrate trihydrate (0.01 mol), nickel(II) nitrate hexahydrate (0.01 mol) and zinc(II) nitrate hexahydrate (0.01 mol) in water (70 ml). This resulted in a blue solution, which was evaporated and dried under vacuum to yield [CuNiZn(MeCOO)₆(H₂O)₃].

To a solution of [CuNiZn(MeCOO)₆(H₂O)₃] (1.75 mmol) in water (15 mL), Na₉[β-SiW₉O₃₄H]·23H₂O (1.75 mmol, prepared according to: G. Herve and A. Teze, Study of alpha-and. beta.-enneatungstosilicates and-germanates Inorg. Chem., 1977, 16, 2115-2117) dissolved in NaOAc/HOAc solution (pH 6) was added in small amounts with vigorous stirring, and was heated to 50° C. for 1 hour. After adding CsCl (0.33 g/mL) solution at room temperature, this produced a light green precipitate of Cs₁₀[SiW₉O₃₇{CuNiZn(L)₃}]. The compound was characterized by Infra-red and High Resolution Mass Spectroscopy, Yield—52%.

### Example 11

Synthesis of {SiW₉O₃₇[CuNiAl(L)]₃}⁻⁹ as cesium salts, where L=H₂O or OAc⁻:

A solution of sodium acetate trihydrate (0.32 mol) in water (70 mL) was added to a filtered, stirred solution of copper(II) nitrate trihydrate (0.01 mol), nickel(II) nitrate hexahydrate (0.01 mol) and aluminium(III) nitrate nonahydrate (0.01 mol) in water (70 ml). This resulted in a blue solution, which was evaporated and dried under vacuum [CuNiAl(MeCOO)₆(H₂O)₃]. To a solution of r [CuNiAl(MeCOO)₆(H₂O)₃] (1.75 mmol) in water (15 mL), Na₉[β-SiW₉O₃₄H]·23H₂O (1.75 mmol, prepared according to: G. Herve and A. Teze, Study of alpha-and. beta.-enneatungstosilicates and-germanates Inorg. Chem., 1977, 16, 2115-2117) dissolved in NaOAc/HOAc solution (pH 6) was added in small amounts with vigorous stirring, and was heated to 50° C. for 1 hour. After adding CsCl (0.33 g/mL) solution at room temperature, this produced a light green precipitate of Cs₉[SiW₉O₃₇{CuNiAl(L)₃}]. The compound was characterized by Infra-red and High Resolution Mass Spectroscopy, Yield—49%.

### Example 12

Synthesis of {SiW₉O₃₇[CuFeGa(L)]₃}⁸⁻ as a cesium salt, where L=H₂O or OAc⁻:

A solution of sodium acetate trihydrate (0.32 mol) in water (70 mL) was added to a filtered, stirred solution of copper(II) nitrate trihydrate (0.01 mol), iron(III) nitrate nonahydrate (0.01 mol) and gallium(II) nitrate (0.01 mol) in water (70 ml). This solution was evaporated and dried under vacuum to yield [CuFeGa(MeCOO)₆(H₂O)₃].

To a solution of [CuFeGa(MeCOO)₆(H₂O)₃] (1.75 mmol) in water (15 mL), Na₉[β-SiW₉O₃₄H]·23H₂O (1.75 mmol, prepared according to: G. Herve and A. Teze, Study of alpha-and. beta.-enneatungstosilicates and-germanates Inorg. Chem., 1977, 16, 2115-2117) dissolved in NaOAc/HOAc solution (pH 6) was added in small amounts with vigorous stirring, and was heated to 50° C. for 1 hour. After adding CsCl (0.33 g/mL) solution at room temperature, this produced a light yellow-green precipitate of Cs₈[SiW₉O₃₇{CuFeGa(L)₃}]. The compound was characterized by Infra-red and High Resolution Mass Spectroscopy, Yield—47%.

### Example 13

Synthesis of {SiW₉O₃₇[CuFeSn(L)]₃}⁷⁻ as a cesium salt, where L=H₂O or OAc⁻:

A solution of sodium acetate trihydrate (0.32 mol) in water (70 mL) was added to a filtered, stirred solution of copper(II) nitrate trihydrate (0.01 mol), iron(III) nitrate nonahydrate (0.01 mol) and tin(IV)acetate (0.01 mol) in water (70 ml). This solution was evaporated and dried under vacuum to yield [CuFeGa(MeCOO)₆(H₂O)₃].

To a solution of [CuFeSn(MeCOO)₆(H₂O)₃] (1.75 mmol) in water (15 mL), Na₉[β-SiW₉O₃₄H]·23H₂O (1.75 mmol, prepared according to: G. Herve and A. Teze, Study of alpha-and. beta.-enneatungstosilicates and-germanates Inorg. Chem., 1977, 16, 2115-2117) dissolved in NaOAc/HOAc solution (pH 6) was added in small amounts with vigorous stirring, and was heated to 50° C. for 1 hour. After adding CsCl (0.33 g/mL) solution at room temperature, this produced a light yellow-green precipitate of Cs₇[SiW₉O₃₇{CuFeSn(L)₃}]. The compound was characterized by Infra-red and High Resolution Mass Spectroscopy, Yield—36%.

### Example 14

Representative Exchange of Alkali Metal Cation with Quaternary Ammonium Cation:

Cs₁₀[SiCu₃(H₂O)₃W₉O₃₇] (300 mg) was dissolved in a beaker containing 50 mL of deionized water. Tetrahexyl ammonium bromide (3.6 g) was dissolved in 100 mL dichloromethane with sonication for 15 min. After mixing the two solutions, two separate phases were formed: the upper phase was the water phase and the lower phase was the oily phase containing [(n-hexyl)₄N]₁₀[SiCu₃(H₂O)₃W₉O₃₇] which was extracted and washed several times with deionized water. The clear solution was then evaporated to dryness.

### Example 15

### Reduction CO₂ in an Undivided Cell:

Constant potential electrolysis was carried out for 1 h at room temperature in an electrolyzer (FIG. 2) containing 2 mM of [(n-hexyl)₄N]ₙ[SiMₐM_{b}M_{c}(LₐL_{b}L_{c})W₉O₃₇] (prepared as detailed in Example 14) and 0.1 M (n-butyl)₄NPF₆ as supporting electrolyte in acetonitrile, a titanium metal working electrode, a carbon cloth counter electrode and a Nafion membrane. The results, amounts of CO and faradaic efficiency (FE) for formation of CO for six [SiMₐM_{b}M_{c}(H₂O)₃W₉O₃₇]ⁿ⁻ anions at various are presented in the Table below.

[SiW₉CuFeGaO₃₇]⁸⁻

| Potential, V | −2.8 | −2.5 | −2.2 | −2.0 | −1.8 | −1.5 | −1.4 |
|---|---|---|---|---|---|---|---|
| Yield, μmol | 83 | 71 | 2 | 0 | 4 | 16 | 0 |
| Faradaic Efficiency | 84 | 96 | 4 | 0 | 28 | 86 | 0 |

[SiW₉Cu₂GaO₃₇]⁹⁻

| Potential, V | −2.8 | −2.5 | −2.2 | −2.0 | −1.8 | −1.5 | −1.4 |
|---|---|---|---|---|---|---|---|
| Yield, μmol | 31 | 11 | 7 | 0 | 0.1 | 10 | 0 |
| Faradaic Efficiency | 21 | 56 | 12 | 0 | 0.4 | 67 | 0 |

[SiW₉CuFeZnO₃₇]⁹⁻

| Potential, V | −2.8 | −2.5 | −2.2 | −2.0 | −1.8 | −1.5 | −1.4 |
|---|---|---|---|---|---|---|---|
| Yield, μmol | 191 | 79 | 2 | 0 | 3 | 10 | 0 |
| Faradaic Efficiency | 44 | 32 | 7 | 0 | 9 | 23 | 0 |

[SiW₉Cu₂ZnO₃₇]¹⁰⁻

| Potential, V | −2.8 | −2.5 | −2.2 | −2.0 | −1.8 | −1.5 | −1.4 |
|---|---|---|---|---|---|---|---|
| Yield, μmol | 94 | 73 | 4 | 0 | 3 | 7 | 0 |
| Faradaic Efficiency | 53 | 42 | 52 | 0 | 8 | 21 | 0 |

[SiW₉CuFeSnO₃₇]⁷⁻

| Potential, V | −2.8 | −2.5 | −2.2 | −2.0 | −1.8 | −1.5 | −1.4 |
|---|---|---|---|---|---|---|---|
| Yield, μmol | 22 | 32 | 2 | 1 | 3 | 7 | 2 |
| Faradaic Efficiency | 26 | 60 | 2 | 5 | 6 | 17 | 8 |

[SiW₉Cu₂SnO₃₇]⁸⁻

| Potential, V | −2.8 | −2.5 | −2.2 | −2.0 | −1.8 | −1.5 | −1.4 |
|---|---|---|---|---|---|---|---|
| Yield, μmol | 36 | 16 | 7 | 0 | 0 | 7 | 4 |
| Faradaic Efficiency | 67 | 45 | 21 | 0 | 0 | 19 | 9 |

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A polyoxometalate compound represented by formula (I):
(Q)ₙ[XMₐM_{b}M_{c}(Lₐ)(L_{b})(L_{c})W₉O₃₇] (I)
or a solvate thereof,
wherein,
X is P, Si, As, Ge, Ga, B, or Al;
Mₐ, M_{b} and M_{c} are each independently selected from the group consisting of: Cr, Mn, Fe, Co, Ni, Cu, Zn, Al, Ga, Sn, Sb, In, Sc, Sr, Mg, Y, Yb, Ba and Ca;
Lₐ, L_{b} and L_{c} are each independently selected from the group consisting of: H₂O, carboxylates, oxyanions, halides or pseudohalides, carbonate, bicarbonate or absent;
Q is a cation such as an alkali metal cation, an alkaline earth metal cation, a lanthanide cation, a nitrogen centered cation or a phosphorous centered cation or any combination thereof;
n is an integer between 4-13; and
wherein at least one of Mₐ, M_{b} and M_{c} is Sn, Al, Zn or Ga or Mₐ, M_{b} and M_{c} are different.

2. The compound of claim 1, wherein Q is a quaternary ammonium cation.

3. The compound of claim 1, wherein Mₐ, M_{b} and M_{c} are different.

4. The compound of claim 1, wherein at least one of Mₐ, M_{b} and M_{c} is Sn, Al, Zn or Ga.

5. The compound of claim 1, wherein the compound is (Q)ₙ[XCu₂M″LₐL_{b}L_{c}W₉O₃₇] and M″ is selected from the group consisting of Sn, Zn, Al, Ga.

6. The compound of claim 1, wherein the compound is (Q)ₙ[XCu₂ZnLₐL_{b}L_{c}W₉O₃₇], (Q)ₙ[XCu₂GaLₐL_{b}L_{c}W₉O₃₇], (Q)ₙ[XCu₂SnLₐL_{b}L_{c}W₉O₃₇], (Q)ₙ[XCu₂AlLₐL_{b}L_{c}W₉O₃₇], (Q)ₙ[XCuFeZnLₐL_{b}L_{c}W₉O₃₇], (Q)ₙ[XCuFeNiLₐL_{b}L_{c}W₉O₃₇], (Q)ₙ[XCuFeAlLₐL_{b}L_{c}W₉O₃₇], (Q)ₙ[XCuNiZnLₐL_{b}L_{c}W₉O₃₇], (Q)ₙ[XCuNiAlLₐL_{b}L_{c}W₉O₃₇], (Q)ₙ[XCuCoZnLₐL_{b}L_{c}W₉O₃₇], (Q)ₙ[XCuCoAlLₐL_{b}L_{c}W₉O₃₇], (Q)ₙ[XCuMnZnLₐL_{b}L_{c}W₉O₃₇] or (Q)ₙ[XCuMnAlLₐL_{b}L_{c}W₉O_{37].}

7. The compound according to claim 1, wherein X is Si or P.

8. A method for reducing carbon dioxide to carbon monoxide, formate salt or formic acid, formaldehyde, methanol, ethane, ethylene, ethanol or any combination thereof, wherein the method comprises reacting the carbon dioxide with a polyoxometalate compound represented by formula (I):
(Q)ₙ[XMₐM_{b}M_{c}(Lₐ)(L_{b})(L_{c})W₉O₃₇] (I)
or a solvate thereof,
wherein,
X is P, Si, As, Ge, Ga, B, or Al;
Mₐ, M_{b} and M_{c} are each independently selected from the group consisting of: Cr, Mn, Fe, Co, Ni, Cu, Zn, Al, Ga, Sn, Sb, In, Sc, Sr, Mg, Y, Yb, Ba and Ca;
Lₐ, L_{b} and L_{c} are each independently selected from the group consisting of: H₂O, carboxylates, oxyanions, halides or pseudohalides, carbonate, bicarbonate or absent;
Q is a cation such as a proton, an alkali metal cation, an alkaline earth metal cation, a lanthanide cation, a nitrogen centered cation or a phosphorous centered cation or any combination thereof;
n is an integer between 4-13;
and wherein the reaction is conducted in an electrochemical cell comprising: a cathode, an anode, optionally a reference electrode, optionally a membrane; and the polyoxometalate compound of Formula (I) as the catalyst for the reduction of carbon dioxide.

9. The method of claim 8, wherein the applied potential is between −3.5-0.0 V vs Fc/Fc⁺.

10. The method of claim 9, wherein the applied potential is −2.5 or −1.5 V vs Fc/Fc⁺.
